(19) United States
(12) Patent Application Publication
(10) Pub. No.: US 2023/0173650 A1
(43) Pub. Date: Jun. 8, 2023

(54) WORK MACHINE

(71) Applicant: Koki Holdings Co., Ltd., Tokyo (JP)

(72) Inventors: Shunya SHINTO, Ibaraki (JP); Hironori MASHIKO, Ibaraki (JP)

(73) Assignee: Koki Holdings Co., Ltd., Tokyo (JP)

(21) Appl. No.: 17/921,967

(22) PCT Filed: Apr. 23, 2021
(86) PCT No.: PCT/JP2021/016540

§ 371 Date: Oct. 27, 2022

(30) Foreign Application Priority Data
Apr. 28, 2020 (JP) 2020-078897

(51) Int. Cl. B25B 23/147; B25B 21/02

(52) U.S. Cl. CPC B25B 23/1475; B25B 21/02

(57) ABSTRACT

A work machine is configured so that multiple groups are prepared in advance as drive modes and so that it is possible to switch between these groups. The work machine having multiple drive modes is configured so that multiple sets (first to third groups) of drive modes are provided and so that it is possible to switch between the first to third groups, whereby it is possible to provide a variety of drive modes to an operator. The operation for switching between the first to third groups includes both a normal operation and a long-press operation of a first switch for changing drive modes in the work machine. This makes it possible for an operator to switch from a standard drive mode group (first group) set as a factory default to a desired drive mode group (second or third group).

### TECHNICAL FIELD

The disclosure relates to a work machine that performs work by operating a tip tool with power such as an electric motor.

### RELATED ART

A work machine is widely used in which a power supply of a detachable battery pack is used to drive a motor to operate a tip tool to perform work. The work machine is provided with a switch for rotating a motor. When an operator (user) turns on the switch, the motor rotates, and when the switch is turned off, the motor stops. Patent Literature 1 is an example of such a work machine. The work machine described in Patent Literature 1 is a work machine of a so-called impact tool. An anvil for holding a tip tool, a hammer for applying a rotational impact force to the anvil, a spindle for rotationally driving the hammer, and a motor for rotationally driving the spindle are provided inside the device body. The technique of Patent Literature 1 discloses an impact tool with various drive modes such as a pulse mode for normal fastening, a tex mode for fastening tex screws, a bolt mode for fastening bolts, and a drill mode for drilling as drive modes for fastening work. When the drive mode is switched between these drive modes, the rotation speed of the motor, the acceleration control of the motor, the pull characteristic of the trigger lever and the like are changed.

FIG. 8 is a diagram showing the relationship between the trigger pull amount and the motor rotation speed when the drive mode is switched in a conventional work machine. The horizontal axis of (A) and (B) is the trigger lever pull amount (unit: mm), and the vertical axis is the motor rotation speed (unit: r.p.m.). In this example, there are two drive modes, the drive mode A and the drive mode A′, as rotation control characteristics of the motor of the working machine; therefore, the maximum rotation speed when the trigger lever is fully pulled is different. In either case, the trigger lever is pulled from the pull amount 0 to the pull amount S₁, and the motor is started and accelerated to near the pull amount S₂ with the same acceleration characteristics. When the pull amount of the trigger lever becomes larger than near S₂, the motor is controlled so that the rotation speed is constant at N₂ in the drive mode A, and the motor is controlled so that the rotation speed is constant at N₁ in the drive mode A′. By changing the motor rotation speed when the trigger pull amount is maximized in this way, the maximum torque during work may be changed.

(B) of FIG. 8 shows an example in which the slope of the acceleration curve of the motor is changed when the drive mode is switched. In the drive mode A and the drive mode A′, the maximum rotation speed N₂ is the same, but in the drive mode A, control is performed so that the maximum rotation speed N₂ is reached near the pull amount S₂. In the drive mode A′, the increase in the rotation speed is small near the pull amount S₂, and finally reaches the maximum rotation speed N₂ near the pull amount S₃, which is close to the maximum pull amount. By changing the relationship between the trigger pull amount and the motor rotation speed in this way, it becomes easier to adjust the speed in the low rotation range by adjusting the pull amount, and the operability is particularly improved when the work machine is often operated with a small amount of trigger lever operation.

(C) of FIG. 8 shows an example in which the slope of the acceleration curve of the motor is changed by switching the drive mode. The horizontal axis is not the pull amount of the trigger lever, but time (unit: sec.). As a premise for this, it is assumed that the trigger lever is fully pulled from time T₁ to time T₂, which is an extremely short elapsed time. In this case, the microcomputer of the work machine controls the acceleration of the motor so that the acceleration is in a desired state instead of controlling the acceleration of the motor in proportion to the pull amount of the trigger lever. That is, the microcomputer controls the rotation of the motor so that the acceleration is gentler in the drive mode A′ than in the drive mode A. In this way, even if the pull operation of the trigger lever is the same, the drive mode A reaches the maximum rotation speed N₂ at the time T₃, while the drive mode A′ reaches the maximum rotation speed N₂ around the time T₄.

### CITATION LIST

### Patent Literature

[Patent Literature 1] Japanese Patent Application Laid-Open No. 2012-11503

### SUMMARY

### Technical Problem

In Patent Literature 1, a number of modes are assigned to one dial, and it is necessary to turn the dial to the position of the desired mode. However, as the types of modes increase, it may be troublesome to turn to the position of the desired mode, or a wrong mode may be selected. In addition, increasing the number of operation parts for mode switching leads to an increase in size and cost of the work machine. In addition, as the number of switchable modes increases, though the user-friendliness has improved, the operator may feel that the characteristics such as the motor rotation start timing when the trigger is pulled, the rotation increase curve, the maximum rotation speed and the like are not to their liking. Patent Literature 1 increases the number of switchable modes by subdividing each drive mode into “strong or weak” or “strong, medium, weak,” and the like. However, due to the increase in the number of drive modes, it becomes necessary to finely operate the dial, which impairs operability.

The disclosure has been made in view of the above background, and the disclosure improves the operability of drive mode selection. In addition, the disclosure provides a work machine capable of supporting various drive modes, such as the operation amount from the time the trigger is operated until the motor is driven, the rotation speed of the motor, the control suited to the work, and the trigger characteristics desired by the operator. The disclosure also provides a work machine that enables switching between groups of drive modes using an operation part provided on the work machine, thereby enabling selection of many drive modes with a small number of operation parts.

### Solution to Problem

The exemplary features of the disclosure described herein are as follows. According to an embodiment of the disclosure, a work machine includes: a motor; a start switch configured to be operable to switch the motor on or off; and a control part configured to rotate the motor in one of multiple drive modes in response to an operation of the switch. The multiple drive modes include a first drive mode in which the motor starts to be driven when the start switch is operated by a first operation amount; and a second drive mode in which the motor starts to be driven when the start switch is operated by a second operation amount larger than the first operation amount. Further, the work machine includes a first switch having a first operation part configured to switch between the multiple drive modes by a first predetermined operation. The work machine is provided with a first group including a part of multiple drive modes and a second group including multiple drive modes at least partly different from the first group, and switching between the first drive mode and the second drive mode is performed by a second predetermined operation of the first operation part, which is different from the first predetermined operation.

According to another embodiment of the disclosure, a work machine includes: a motor; a start switch configured to be operable to switch the motor on or off; a drive circuit that supplies electric power from a power supply to the motor; a control part configured to rotate the motor in one of multiple drive modes; and a first switch for switching the drive modes by a first predetermined operation. A first group including a part of the multiple drive modes, and a second group of drive modes including at least a part of drive characteristics different from the first group are provided. The first group and the second group are switchable by a second predetermined operation different from the first predetermined operation performed for switching the drive modes in the first group. Each of the drive modes is set to be different in at least one control characteristic of an operation amount from when the switch is operated until the motor starts rotating, a maximum rotation speed of the motor, a minimum rotation speed of the motor, a slope of an acceleration curve, and an arrival time until reaching the maximum rotation speed. That is, a first drive mode defined as the first group and a second drive mode are set differently.

According to another embodiment of the disclosure, a work machine includes a start switch that switches a motor on or off, and settings in each of multiple drive modes include a startup delay time for the motor to start rotating after the start switch is turned on. Here, a first predetermined operation and a second predetermined operation are different operations performed on a first operation part. In addition, the work machine includes multiple indicators (for example, multiple LEDs) for displaying the drive modes, and the currently set mode is displayed by the indicators. When the second predetermined operation is performed, a control part of the work machine changes a display mode of the indicators, or notifies the operator that the second predetermined operation has been performed by using a notification part that is different from the indicators. The second predetermined operation is different in at least one of the number of times of operations and an operation time of a common operation part.

According to still another embodiment of the disclosure, the first switch is a press button as the first operation part, and the first predetermined operation is one press operation of the press button, and each time the first predetermined operation of the first switch is performed, the drive modes in the group are switched in order. The second predetermined operation is a long press operation of the press button, and when the second predetermined operation of the first switch is performed, the first group and the second group are switched. The first switch may be a touch sensitive switch, in which case the first predetermined operation is one touch operation of the sensitive switch, and each time the first predetermined operation of the first switch is performed, the drive modes in the group are switched in order. Further, the second predetermined operation is a touch operation of the sensitive switch continuously for a predetermined time, and the first group and the second group are switched when the second predetermined operation of the first switch is performed.

According to still another embodiment of the disclosure, the power supply is a detachable battery pack, and the work machine further includes a body part that accommodates the motor, a handle part that extends from the body part, and a battery pack mounting part that is formed at an end of the handle part and away from the body part, and the first operation part is provided in the battery pack mounting part. Here, the work machine is provided with multiple operation parts, and a combination of the operation parts used for the predetermined operation is different between the first predetermined operation and the second predetermined operation. Further, the control part of the work machine is provided with a microcomputer and a storage device, and parameters for controlling drive modes included in the first group and the second group are registered in advance in the storage device.

According to still another embodiment of the disclosure, the work machine further includes a communication device that enables wireless communication between an external device and the microcomputer, and the parameters for controlling the drive modes included in the second group are configured to be rewritable from an outside via the communication device. In addition, the work machine is provided with a reset function for returning to a predetermined drive mode, or a reset function for returning settings to factory default settings.

### Effects of Invention

According to this disclosure, the work machine with good operability of drive mode selection may be provided.

### BRIEF DESCRIPTION OF THE DRAWINGS

FIG. 1 is a longitudinal sectional diagram showing the overall structure of the impact tool 1 according to an embodiment of the disclosure.

FIG. 2 is a schematic block diagram showing the circuit configuration of the impact tool 1 and the battery pack 90 of this embodiment.

FIG. 3 is a top diagram of the operation panel part 60 of the impact tool 1 of FIG. 1.

FIG. 4 is a transition diagram of drive modes and group switching in the impact tool 1 of this embodiment.

FIG. 5 is a diagram showing the relationship between the trigger pull amount and the motor rotation speed in the impact tool 1 of this embodiment.

FIG. 6 is a diagram showing the relationship between the elapsed time after startup and the motor rotation speed in the impact tool 1 of this embodiment.

FIG. 7 is a flow chart showing a switching procedure of drive modes in the impact tool 1 of this embodiment.

FIG. 8 is a diagram showing the relationship between the trigger pull amount and the motor rotation speed when the drive mode is switched in a conventional work machine, and (A) is an example of changing the rotation speed, and (B) is an example of changing the slope of the acceleration curve, and (C) is an example of changing the time to reach the maximum rotation speed.

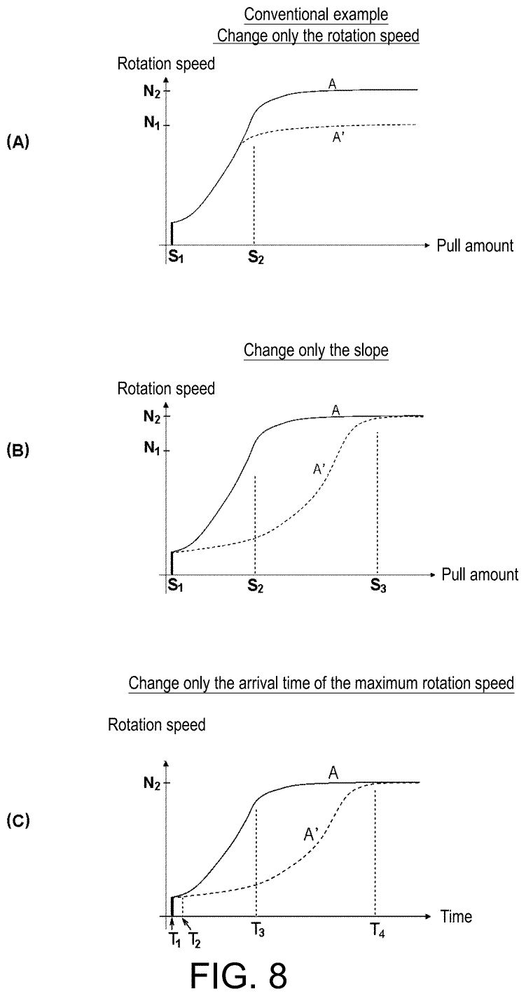

### DESCRIPTION OF THE EMBODIMENTS

### First Embodiment

Embodiments of the disclosure will be described below with reference to the drawings. In the drawings below, an impact tool 1 is used as an example of a work machine, and the same parts are denoted by the same reference numerals. Further, in this disclosure, the front, rear, left, right, up and down directions are described as the directions shown in the drawings.

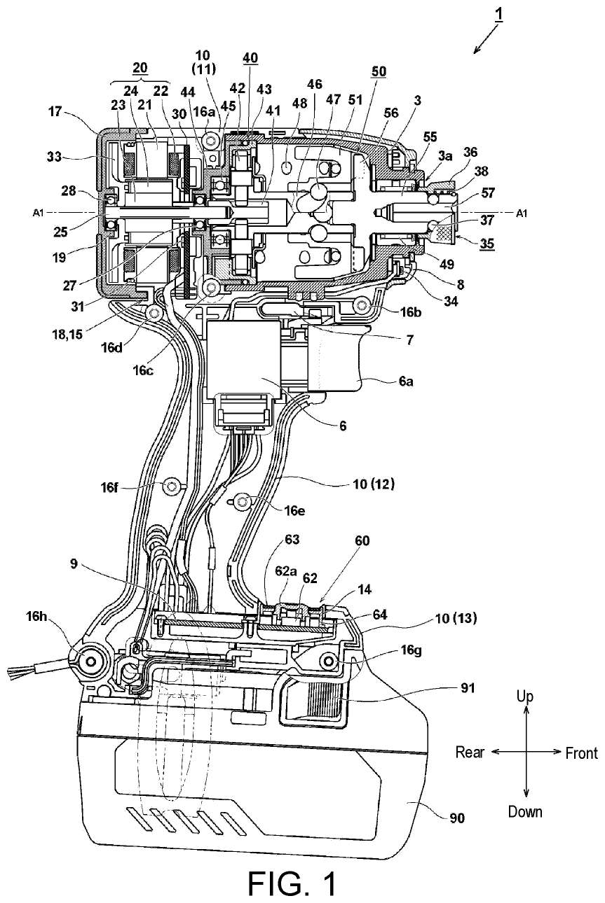

FIG. 1 is a longitudinal sectional diagram showing the impact tool 1 according to an embodiment of the disclosure. The impact tool 1 fastens a tip tool such as a bit (not shown), and is an example of a work machine. The impact tool 1 uses a rechargeable battery pack 90 as a power supply and a motor 20 as a drive source to drive a rotary impact mechanism, converts the rotation of a rotating member into intermittent impact force in the rotational direction by the rotary impact mechanism, and drives an anvil 55 connected to the impact mechanism. The housing of the impact tool 1 is configured by a left-and-right-divided main housing 10, a hammer case 3 connected to the front side of the main housing 10, and a rear cover (rear housing) 17 covering a rear side opening of the main housing 10. The main housing 10 includes a substantially cylindrical body part 11 extending in the front-rear direction, a handle part 12 connected to the body part 11 to form a substantially T-shape in a side view, and a battery pack mounting part 13 formed below the handle part 12. The main housing 10 of this embodiment has a rear opening 15 formed on the rear side of the cylindrical body part 11, and the rear opening 15 is closed by being covered with an opening surface 18 of a rear cover 17. A metal hammer case 3 is connected to the front opening of the body part 11. The hammer case 3 is fixed to be sandwiched between the left-and-right-divided main housing 10.

The handle part 12 extends downward to be substantially orthogonal to the central axis (rotation axis A1) of the body part 11, and a trigger lever 6a is provided at a position where the operator's index finger is positioned when the operator grips the handle part 12. The trigger lever 6a is an operating part of a start switch (trigger switch 6) for controlling on or off of the motor. A forward/reverse switching lever 7 for switching the rotational direction of the motor is provided above the trigger lever 6a. A lower part within the handle part 12 is formed with the battery pack mounting part 13 for mounting the battery pack 90 thereon. The battery pack mounting part 13 is an enlarged diameter part formed to expand radially (forward, rearward, rightward, and leftward, which are orthogonal directions) from the longitudinal central axis of the handle part 12. A control circuit board 9 for controlling the entire impact tool 1 is provided in the internal space of the battery pack mounting part 13.

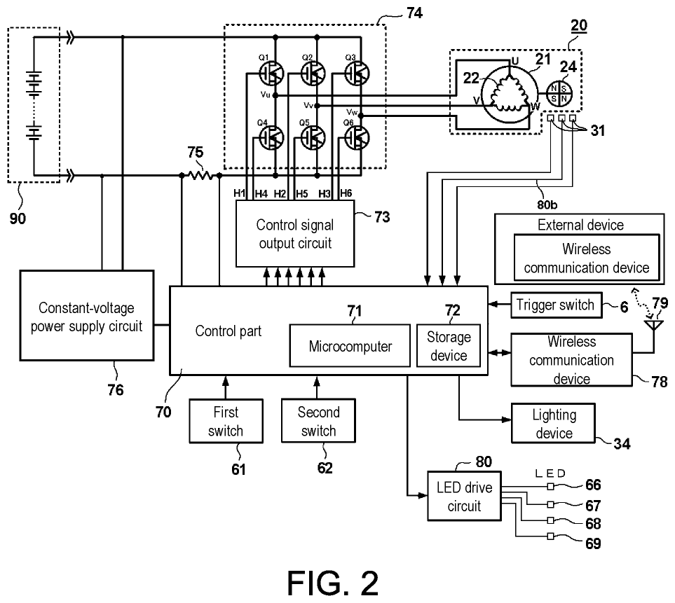

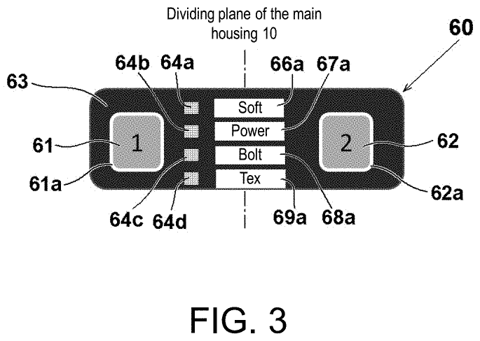

On the front and back sides of the control circuit board 9, various control elements (not shown) for controlling the on/off, rotational direction, and rotation speed of the motor 20 are mounted. A push-type first switch 61 (see FIG. 2 to be described later) and a second switch 62 are provided on the upper surface of the control circuit board 9. The first switch 61 (see FIG. 2 to be described later) and the second switch 62 are fixed to the control circuit board 9 by soldering, and the periphery thereof configures an operation panel part 60. The operation panel part 60 includes the first switch 61 (see FIG. 2 to be described later) and the second switch 62, switch pressing surfaces 61a (see FIG. 3 to be described later) and 62a disposed on the upper surfaces thereof, and a switch holder 64 disposed around them. The upper surface of the switch holder 64 is sealed with a protection sheet 63 to prevent water and dust from entering the internal space of the switch holder 64.

The battery pack 90 accommodates multiple secondary batteries such as lithium ion batteries, and may be detached from the front side of the main housing 10 by pushing a latch button 91 and moving it to the front side. Although not shown, the battery pack 90 is equipped with a voltage check circuit, and a multi-segment LED display device (not shown) and a check button (not shown) to be operated by an operator are provided on a part of the housing of the battery pack 90. When the operator operates the check button to turn it on, the number of LEDs corresponding to the remaining battery level is lit for several seconds. In this embodiment, since the voltage check circuit is provided on the battery pack 90 side, the main body of the impact tool 1 is not provided with a remaining battery check function. When the battery pack 90 is neither charged nor discharged, the microcomputer of the battery pack 90 shifts to a sleep state, but when the trigger lever 6a is pulled after the battery pack 90 is attached to the main body of the work machine such as the main body of the impact tool 1, the microcomputer shifts from the sleep state to the active state. Further, by pressing the check button of the battery pack 90, the microcomputer may be activated. In addition, the impact tool 1 of this embodiment may be powered by any power supply, such as by a commercial power supply supplied through an AC power cable instead of using the battery pack 90.

The divided-type main housing 10 is made of synthetic resin, and is formed with multiple screw bosses 16a to 16h for screwing on one side (left side), and formed with screw holes on the other side (right side). The left and right sides of the main housing 10 are screwed together with the hammer case 3 sandwiched therebetween, and an integral rear cover 17 is then attached to the main housing 10. The rear cover 17 is moved from the rear side to the front side along the rotation axis A1 and screwed to the main housing 10 with two screws (not shown) extending in a direction parallel to the rotation axis A1. Two screw bosses (not visible in the figure) formed with internal threads for engaging screws (not shown) are provided near the right end and near the left end of the rear opening 15 of the main housing 10. Further, two screw holes (not visible in the figure) for passing screws (not shown) are provided near the right end and near the left end of the rear cover 17.

The hammer case 3 has an opening at its rear end and a shape in which the tip of the outer peripheral surface is narrowed. A cylindrical through hole 3a is formed at the tip, and a bearing 49 such as a needle bearing is mounted inside the through hole 3a. In the manufacturing and assembling process, the bearing 49, a rotary impact mechanism 50 including the anvil 55, the speed reduction mechanism 40, and the like are incorporated inside from the rear side opening of the hammer case 3, and the interior is sufficiently filled with grease for lubrication, and the opening on the rear side is closed with an inner cover 44. The anvil 55 exposed to the front side from a through hole on the front side of the hammer case 3 is provided with a tip tool holding part 35 for holding a tip tool (not shown).

The motor 20 as a drive source is accommodated inside a space defined by the body part 11 and the rear cover 17. A rotation shaft 25 of the motor 20 is disposed to extend in the front-rear direction. The speed reduction mechanism 40 using a planetary gear that decelerates the rotational force of the motor 20 provided on the front side of the rotation shaft 25 and the rotary impact mechanism 50 for converting the rotational force output by the speed reduction mechanism 40 into an impact force and transmitting it to the tip tool holding part 35 are disposed on the rotation axis A1. The brushless motor 20 is driven by an inverter circuit (not shown), and is disposed with a rotor that rotates on the inside and a stator that does not rotate on the outside. The rotor is configured by fixing permanent magnets 24 to a rotor core 23 fixed to the rotation shaft 25. The stator has a stator core 21 fixed on the outer peripheral side to the body part 11 of the main housing 10 and a coil 22 wound thereon. The rotation shaft 25 passing through the rotor core 23 is supported by a bearing 27 on the front side and by a bearing 28 on the rear side. The bearing 27 is a ball bearing whose outer ring is held by the inner cover 44. The bearing 28 is a ball bearing and held by a bearing holder 19 formed on the inner wall side of the rear cover 17.

In the motor 20, the stator core 21 that forms a magnetism forming circuit on the stator side is completely accommodated in the inner space of the main housing 10. A substantially circular circuit board 30 on which a semiconductor switching element such as a Hall IC 31 is mounted is provided on the front side of the motor 20. A cooling fan 33 is provided behind the rotation shaft 25 of the motor 20. The cooling fan 33 sucks outside air from an air hole (not visible in the figure) provided on the radial outer side and flows it forward in the direction of the rotation axis A1, thereby cooling the electronic elements mounted on the motor 20 and the circuit board 30. The left and right side surfaces of the rear cover 17 are provided with air windows (not visible in the figure) serving as air inlets. In this way, the main housing 10 and the rear cover 17 define a space for accommodating the motor 20, but any type of motor 20 may be used, and is not limited to the brushless DC motor shown in FIG. 1. For example, a DC motor with brushes accommodated inside a cylindrical metal case may be fixed to the main housing 10, in which case the rear cover 17 may be configured so as not to support the rotation shaft.

The speed reduction mechanism 40 decelerates the output of the motor 20 at a predetermined reduction ratio and transmits it to a spindle 46, and is a mechanism using a planetary gear. The speed reduction mechanism 40 includes a sun gear 41 fixed to the tip of the rotation shaft 25 of the motor 20, a ring gear 43 provided to surround the sun gear 41 with a distance therebetween on the outer peripheral side, and multiple planetary gears 42 disposed in a space between the sun gear 41 and the ring gear 43 and meshing with both of these gears. The ring gear 43 has a gear formed on the inner peripheral surface of a ring-shaped member and is fixed to the main housing 10 via the inner cover 44. The sun gear 41 is a spur gear serving as an input part of the speed reduction mechanism 40. Between the outer gear surface of the sun gear 41 and the inner gear surface of the ring gear 43, the three planetary gears 42 revolve around the sun gear 41 while rotating, and the spindle 46, functioning as a planetary carrier, rotates in a state of being decelerated at a predetermined ratio.

The inner cover 44 is a component manufactured by integral molding of synthetic resin, and is held by the body part 11 of the main housing 10 to be sandwiched from the left-right direction. At this time, the inner cover 44 is held so as not to rotate relative to the main housing 10. The main role of the inner cover 44 is to hold the bearing 27 provided in the rotary impact mechanism and to hold a bearing 45 formed on the front side of the motor 20 for axial positioning. The bearing 45 held by the inner cover 44 is for axially supporting the rear end of the spindle 46, and a ball bearing is used, for example.

A spindle cam groove is formed on the outer peripheral surface of the spindle 46 which is integrally formed with the planetary carrier part. The hammer 51 is disposed on the outer peripheral side of the shaft part of the spindle 46, and a hammer cam groove is formed on the inner peripheral side. The hammer 51 is held by a cam mechanism using a cam ball 47 movable inside the spindle cam groove and the hammer cam groove. A hammer spring 48 abuts on the hammer 51 side on the front side and on the planetary carrier part of the spindle 46 on the rear side.

At the rear end of the anvil 55, two blade parts 56, which are to be struck, are formed at positions spaced apart by 180 degrees in the circumferential direction. The blade part 56 has a shape extending radially outward and is struck by the striking claw of the hammer 51. The rotating bodies of the spindle 46 and the anvil 55 are supported on the inner wall of the hammer case 3 by the bearing 49 on the front side. The shape of the hammer 51 and the blade part 56 may be any shape, and the number of the blade parts 56 may be three instead of two, or may be another number.

The tip tool holding part 35 includes a mounting hole 57 having a hexagonal cross-section extending axially rearward from the front end of the anvil 55, two radially penetrating holes formed at two locations in the circumferential direction for disposing steel balls 37, and a sleeve 36 provided on the outer peripheral side. A spring 38 is mounted inside the sleeve 36 to bias the sleeve 36 rearward. A lighting device 34 for illuminating the vicinity of the tip of the tip tool (not shown) is provided below the tip tool holding part 35. One or multiple light emitting diodes (LEDs) are used as the lighting device 34, and an irradiation window 8 that transmits light is provided on the front side of the lighting device 34. The irradiation window 8 is a synthetic resin cover member, and may be configured to include a lens for directing light in a specific direction.

The rotational driving force of the motor 20 is transmitted from the rotation shaft 25 to the rotary impact mechanism 50 through the speed reduction mechanism 40 using planetary gears. The speed reduction mechanism 40 transmits the output of the motor 20 to the spindle 46, and the revolutionary motion of the planetary gear 42 is converted into the rotational motion of the planetary carrier part, causing the spindle 46 to rotate. When the spindle 46 rotates, the hammer 51 rotates accordingly, causing the anvil 55 to rotate. As long as the load applied from the hammer 51 to the anvil 55 is small, the hammer 51 rotates almost in conjunction with the spindle 46. When the reaction force received from the tip tool increases, the movement of the cam ball 47 slightly changes the relative positions of the hammer 51 and the spindle 46 in the rotational direction, and as the relative positions of the hammer 51 and the spindle 46 in the rotational direction slightly change, the hammer 51 moves backward. The backward movement of the hammer 51 is a movement while compressing the hammer spring 48.

Due to the backward movement of the hammer 51, the striking claw of the hammer 51 climbs over the blade part 56 of the anvil 55, and the engagement between the two is released. Then, the hammer 51 is rapidly accelerated in the rotational direction and forward by the rotational force of the spindle 46, the elastic energy accumulated in the hammer spring 48, and the action of the cam mechanism, and is pushed forward by the biasing force of the hammer spring 48. That is, the hammer 51 is moved toward the anvil 55, and the striking claw of the hammer 51 reengages with the blade part 56 of the anvil 55 and starts to rotate integrally. At this time, a strong rotational impact force is applied to the anvil 55, whereby the rotational impact force is transmitted to the tip tool (not shown) attached to the anvil 55. After that, the same operation is repeated to fasten the screw or the like.

FIG. 2 is a circuit diagram of the drive control system of the motor 20 of the impact tool 1 of this embodiment. The impact tool 1 drives the motor 20 as a discharge load using the power of the detachably mounted battery pack 90. Rotation control of the motor 20 is performed by a control part 70. An inverter circuit 74, a constant-voltage power supply circuit 76, and the control part 70 shown in this circuit diagram are mounted on the same control circuit board 9 (see FIG. 1). The output of battery pack 90 is input to the inverter circuit 74. The inverter circuit 74 includes six switching elements Q1 to Q6, and its switching operation is controlled by gate signals H1 to H6 supplied from a control signal output circuit 73 according to instructions from the control part 70. The six switching elements Q1 to Q6 of the inverter circuit 74 are connected in a three-phase bridge configuration. The switching elements Q1 to Q6 use metal oxide semiconductor field effect transistors (MOSFETs), but they may use insulated gate bipolar transistors (IGBTs).

The drains or sources of the six switching elements Q1 to Q6 of the inverter circuit 74 are connected to the U-phase, V-phase, and W-phase of the delta-connected coil 22. The drain terminals of the switching elements Q1 to Q3 are commonly connected to the positive side of the battery pack 90. In addition, the drain terminals of the switching elements Q4 to Q6 are connected to the V-phase, U-phase and W-phase terminals of the motor, respectively. Inside the stator core 21 of the motor 20, the rotor with the permanent magnets 24 rotates. The control part 70 may detect the rotational position of the motor 20 by detecting the positions of the permanent magnets 24 mounted on the rotor with the three Hall ICs 31 serving as rotational position detection elements.

The control part 70 is a control part for controlling the on/off and rotation of the motor, and includes a microcomputer 71. The control part 70 controls the rotation speed of the motor 20 based on the activation signal input by the operation of the trigger switch 6 for turning on and off the motor 20 and the drive mode set by the drive mode switching button (first switch 61), and controls the energization time and drive voltage of the U, V, and W phases of the coil. The microcomputer of the control part 70 outputs to the control signal output circuit 73 an instruction signal for controlling the drive signals H1 to H6 output to the respective gates of the six switching elements Q1 to Q6 of the inverter circuit 74. The second switch 62 is a switch for turning on the lighting device 34 (see FIG. 1). Every time the second switch 62 is pressed, the three states of the “continuous lighting” state, the “SW interlocking” state in which the lighting is interlocked with the trigger switch 6, and the “OFF” state are sequentially switched. The first switch 61 corresponds to a first operation part or drive mode selection part in the disclosure, and the second switch 62 corresponds to a second operation part in the disclosure.

The switching elements Q1 to Q6 perform switching operations based on the drive signals H1 to H6 input from the control signal output circuit 73, and convert the DC voltage supplied from the battery pack 90 as three-phase (U-phase, V-phase, W-phase) voltages Vu, Vv and Vw to the motor 20. The magnitude of the current supplied to the motor 20 is detected by the control part 70 by detecting the voltage across a shunt resistor 75 connected between the battery pack 90 and the inverter circuit 74. A predetermined current threshold corresponding to the set rotation of the motor 20 is set in advance in the control part 70. When the detected current value exceeds the threshold, the switching operation of the inverter circuit 74 is stopped to stop driving the motor 20. In this way, the occurrence of burnout or the like due to excessive current flowing through the motor 20 is prevented.

The constant-voltage power supply circuit 76 is a power supply circuit that is directly connected to the output side of the battery pack 90 and supplies a stabilized reference voltage (low voltage) direct current to the control part 70 configured by a microcomputer or the like. The constant-voltage power supply circuit 76 includes a diode, a smoothing electrolytic capacitor, an IPD circuit, a regulator, and the like. An LED drive circuit 80 is connected to the control part 70. The LED drive circuit 80 is a circuit for independently controlling four light emitting diodes (LEDs) 66-69. Although not shown here, the LED drive circuit 80 is supplied with power from the constant-voltage power supply circuit 76, and controls the lighting on/lighting off state of the LEDs 66 to 69, the brightness of light, the color of light emitted, and the form of light emission according to instructions from the microcomputer 71. This embodiment may be realized by using monochromatic LEDs as the LEDs 66 to 69, but multicolor LEDs capable of displaying two or more colors may be used.

A wireless communication device 78 is connected to the control part 70. The wireless communication device 78 enables one-way or two-way communication with an external information terminal, work machine, and the like, and is connected to an antenna 79. The wireless communication device 78 enables short-distance communication of several meters to several tens of meters, and may use Bluetooth (registered trademark of Bluetooth SIG, Inc. USA), for example. Using close proximity wireless communication, it is possible to read and write information stored in a storage device 72 from an external information terminal such as a smartphone (not shown).

FIG. 3 is a top diagram of the operation panel part 60 of FIG. 1. The main housing 10 is formed so that everything from the body part 11 to the battery pack mounting part 13 is divided into right and left sides. An opening 14 (see FIG. 1) is formed so as to straddle the dividing surface, and the operation panel part 60 is provided in the opening 14. The opening 14 intersects the left and right dividing plane (vertical plane) of the main housing 10 and is shaped to extend left and right across the dividing plane. The operation panel part 60 has a substantially rectangular shape with long sides extending in the left-right direction. The protection sheet 63 is attached to cover the entire operation panel part 60 including the button parts (61a, 62a) of the first switch 61 and the second switch 62 and the upper surfaces of the LEDs (66 to 69). The outer edge of the upper surface of the operation panel part 60 is sandwiched by the opening 14 with almost no gap.

Two switch pressing surfaces 61a and 62b are formed in the horizontal direction of the operation panel part 60. The switch pressing surfaces 61a and 62b are slightly movable in the vertical direction, and by pressing them, a switch operation, which will be described later, is performed. The first switch 61 and the second switch 62 (see FIG. 2 for both) are disposed on the back side of the switch pressing surfaces 61a and 62b (on the lower side when viewed in FIG. 1). The first switch 61 is a push-type switch for setting the “drive mode” of the impact tool 1. In the impact tool 1 of this embodiment, four “drive modes” are provided in advance, including a “soft mode” that suppresses output, a “power mode” that increases output, a “bolt mode” that drives the motor suitable for fastening bolts, and a “tex mode” that drives the motor suitable for fastening screws.

The protection sheet 63 is provided with four LED display windows 64a to 64d disposed side by side in the vertical direction, and on the right side thereof, the name of the “drive mode” indicated by the lighting state through the LED display windows 64a to 64d is displayed. The LED display windows 64a to 64d are semi-transparent parts formed in the protection sheet 63 to allow light to pass through, and have four LEDs 66 to 69 (see FIG. 2) disposed behind them (lower side when viewed in FIG. 1). Here, as the “drive mode” of the impact tool 1, four modes are provided, including a soft mode 66a, a power mode 67a, a bolt mode 68a, and a text mode 69a. One of the LEDs 66 to 69 corresponding to the selected “drive mode” is lit, and light is transmitted through the corresponding display windows 64a to 64d, whereby the operator may easily see which “drive mode” is set.

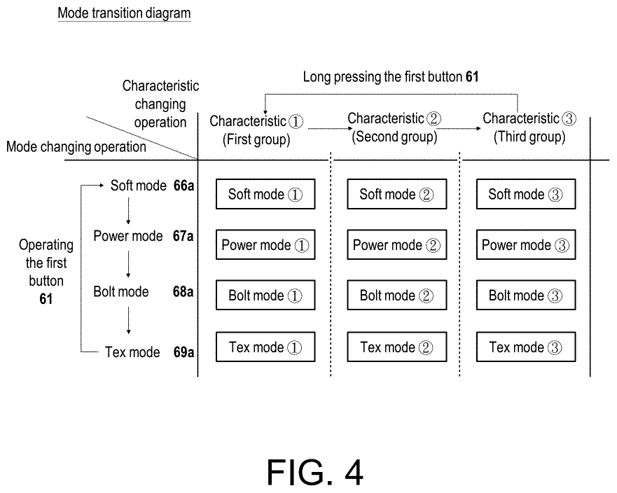

FIG. 4 is a transition diagram of drive modes in the impact tool 1 of this embodiment. As described above with reference to FIG. 3, each time the first switch 61 is pressed, the drive mode of the impact tool 1 is switched in the order from “soft mode” to “power mode” to “bolt mode” to “tex mode” to “soft mode,” and so on. This one-time pressing of the first switch 61 is the “drive mode switching operation.” The microcomputer 71 of the control part 70 rotates the motor 20 according to the control method of the set drive mode, and the parameters that define the drive characteristics of the motor 20 are stored in advance in the storage device 72 included in the control part 70. In addition to these parameters, the storage device 72 stores history information of various data managed by the microcomputer 71. The parameters may be changed by operating an external device using the wireless communication device. In addition, the “drive mode switching operation” corresponds to a first predetermined operation or a second selection operation in the disclosure.

When the trigger lever 6a is pulled, the microcomputer 71 receives an on/off signal (high or low) and an electric signal corresponding to the pull amount (stroke) of the trigger lever 6a. The microcomputer 71 controls the inverter circuit 74 by executing a program for controlling the rotation of the motor 20 using those signals and parameters according to the set drive mode.

In the conventional impact tool 1, these parameters are fixed for each drive mode, and the operator cannot change these parameters. Therefore, in order to increase the number of drive modes that may be changed by the operator, the number of stages that may be switched is increased; for example, it is necessary to design the product with two drive modes including a soft mode and a power mode to have more types of drive modes, such as a soft mode, a middle mode, and a power mode. In addition, if the number of drive modes is increased, the number of times the first switch 61 must be pressed increases, thereby degrading operability. Therefore, in this embodiment, while the total number of modes to be switched each time the first switch 61 is pressed is fixed at four, multiple drive mode groups are assigned so that the characteristics of the three groups, circle 1 to circle 3, may be switched. This switching is performed by long pressing the first switch 61, for example, by keeping the first switch 61 pressed for five seconds or more. Switching by this long press operation is a “group switching operation.” In addition, this long press operation or the “group switching operation” using an external device, which will be described later, corresponds to the first selection operation in the disclosure.

The characteristics of the circled 1 group are preset as the default state of the impact tool 1. The characteristics of the circled 1 group cannot be changed, and if a group switching reset operation is performed, the setting of the circled 1 group is returned to regardless of which group is set. The drive mode characteristics set in the circled 1 group may be set in the same manner as in the conventional impact tool. In the impact tool 1 of this embodiment, a drive mode group set by a circled 2 group and a drive mode group further set by a circled 3 group are set in advance. The circled 2 group and circled 3 group are set in advance at the time of shipment from the factory, and the control characteristics of the same drive mode in the circled 1 to circled 3 groups are different. By long pressing the first switch 61, the operator may switch the group as a whole in the order of the first group (characteristic 1) to the second group (characteristic 2) to the third group (characteristic 3). The operation of switching between the first group, the second group, and the third group in this way may also be realized by adding a dedicated switching button. However, it is often difficult to add a new button to a work machine such as the impact tool 1 due to space constraints. Therefore, in this embodiment, by changing the operation mode of the first switch 61, the group switching operation is made possible. In addition, the “group switching operation” may be realized by pressing the first switch 61 and the second switch 62 at the same time instead of long pressing the first switch 61. In addition, in work machines other than the impact tool 1, various operation parts such as a forward/reverse switch, a battery pack remaining amount display switch, a speed switching dial, and the like may be provided, and the “group switching operation” may be realized by using these operation parts and the first switch 61 or the second switch 62. In this way, by changing the combination of the operation parts that operate the “drive mode switching operation” and the “group switching operation,” it is possible to suppress unintended change of the drive mode by the operator.

By simultaneously pressing the first switch 61 and the second switch 62, the first group, the second group, and the third group are switched in order as indicated by the arrows, and then when the first switch 61 is long pressed when the third group is set, it returns to the first group again. In this way, by performing a predetermined operation (long press of the first switch) on the main body side of the work machine (impact tool 1), the first to third group settings pre-stored in the work machine main body may be called as desired.

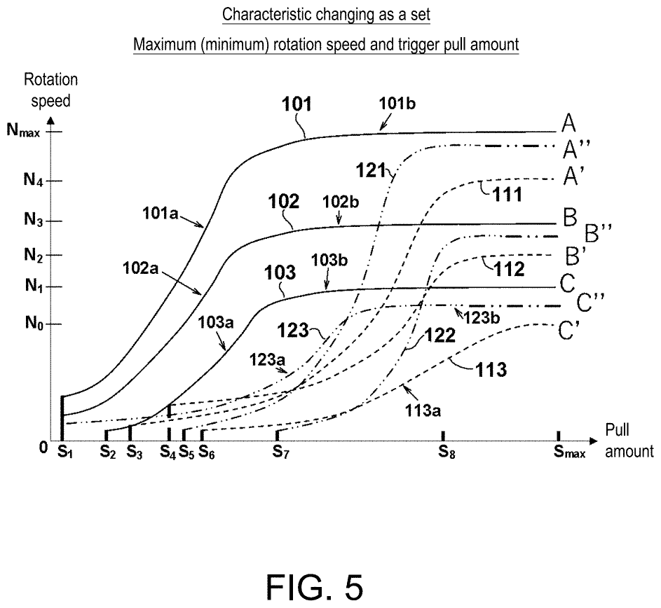

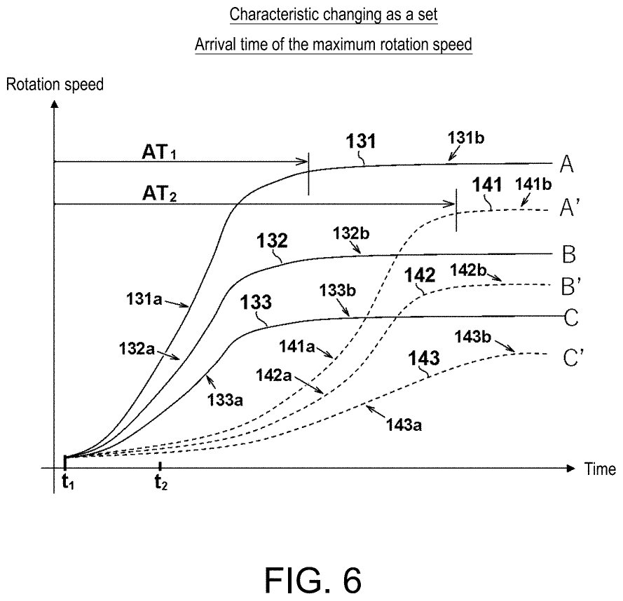

Here, as the default characteristics, soft mode circled 1, power mode circled 1, bolt mode circled 1, and tex mode circled 1 are set in group 1; soft mode circled 2, power mode circled 2, bolt mode circled 2, and tex mode circled 2 are set in group 2; and soft mode circled 3, power mode circled 3, bolt mode circled 3, and tex mode circled 3 are set in group 3. The difference in control of the same drive mode between groups 1 to 3 is that at least one control characteristic of the maximum rotation speed, minimum rotation speed, slope of the acceleration curve, and time to reach the maximum rotation speed of the motor is different and is set according to the work target. A specific example in which such drive mode groups are divided into multiple groups and the drive characteristics may be switched on a group-by-group basis will be described with reference to FIGS. 5 and 6.

FIG. 5 is a diagram showing the relationship between the trigger pull amount and the motor rotation speed in the impact tool 1 of this embodiment. For example, in group 1 registered in advance, three drive modes A to C shown by a drive characteristic 101, a drive characteristic 102, and a drive characteristic 103 are performed with respect to the trigger pull amount. At this time, the drive characteristic 101 and the drive characteristic 102 indicate that the motor 20 is started when the trigger lever 6a is pulled by the pull amount S₁, and the drive characteristic 101 and the drive characteristic 102 rise as shown by arrows 101a and 102a in proportion to the pull amount, and reach the set maximum rotation speeds Nₘₐₓ and N₃, respectively, when the pull amount exceeds S₇, that is, about half the maximum pull amount Sₘₐₓ. As for the drive characteristic 103, the motor 20 is started with a delay when the trigger lever 6a is pulled by the pull amount S₂ (>S₁), and the drive characteristic 103 rises slowly as indicated by an arrow 103a, and reaches the set maximum rotation speed N₁ when the pull amount exceeds S₇. These drive characteristics 101 to 103 are the drive characteristics set in the conventional impact tool 1 as default characteristics, and are the drive characteristics defined in group 1 of this embodiment.

Drive characteristics 111 to 113 are control characteristics set as group 2 registered in advance. As shown in FIG. 4, when the group 1 is changed to the group 2, the drive characteristics 101 to 103 are switched to the drive characteristics 111 to 113 collectively. The drive characteristics 111 and 112 indicate that the motor 20 is started with a delay when the trigger lever 6a is pulled by pull amounts S₃ and S₄ (S₄>S₃>S₂>S₁). In such a driving state, the control mode is particularly easy to use in a work in which the tip tool is driven in a low-speed rotation region while adjusting the trigger lever 6a. In addition, the drive characteristics 111 and 112 are not preferable when the work is to be performed quickly at high speed, for example, when the work is to be performed by fastening a wood screw at high speed. The drive characteristic 113 provides a rising delay time so that the motor 20 is started only when the trigger lever 6a is pulled by the pull amount S₇. When the motor 20 starts, the rotation speed of the motor 20 increases very slowly as indicated by the arrow 113a, and reaches the lowest set rotation speed N₀ near the pull amount of Sₘₐₓ. The pull amounts S₁ to S₇ correspond to an operation amount in the disclosure.

As described above, in this embodiment, the drive characteristics 101 to 103 defined as the first group in this embodiment may be switched to the drive characteristics 111 to 113 defined as the second group. Therefore, the operator may select one of the first group and the second group according to the work contents. The total number of groups different from the first group is not limited to two (the first group and the second group), and one may be added and the drive characteristics 121 to 123 may be provided as the third group. The drive characteristics 121 to 123 of the third group are intermediate between the drive characteristics 101 to 103 of the first group and the drive characteristics 111 to 113 of the second group. In the example of the drive characteristics of FIG. 5, the drive characteristics of the first to third groups each having three drive modes have been described, but as shown in FIG. 3, in the impact tool 1 of this embodiment, since each of the first to third groups includes four drive modes, the impact tool 1 may set four drive characteristics in each group and switch them as a set.

FIG. 6 is a diagram showing the relationship between the trigger pull amount and the motor rotation speed in the impact tool 1 of this embodiment. The microcomputer 71 of the control part 70 makes adjustments based on the variable resistance value of the trigger switch 6 that changes when the trigger lever 6a is pulled, and is electrically determined. For the operator, this control changes the time required for the motor 20 to reach the set rotation speed when the trigger lever 6a is pulled by the maximum operation amount. FIG. 6 shows drive characteristics 131 to 133 defined as the first group and drive characteristics 141 to 143 defined as the second group. The difference in control between the drive characteristics 131 to 133 is the maximum rotation speed. The drive characteristic 131 has a high maximum rotation speed, and the drive characteristic 133 has a low maximum rotation speed, and the drive characteristic 132 has a maximum rotation speed between the drive characteristics 131 and 133. The acceleration characteristics of the drive characteristics 131 to 133 are controlled to have substantially the same slope according to the maximum rotation speed, and the arrival time until reaching the maximum rotation speed is almost the same at AT₁, as indicated by arrows 131b to 133b.

The drive characteristics 141 to 143 defined as the second group have lower maximum rotation speeds than the drive characteristics 131 to 133 defined as the first group, and also have slower reaction when the trigger lever 6a is started to be pulled, and as shown by arrows 141a and 142a, the arrival time of the motor 20 to arrows 141b and 142b is AT₂ (however, AT₂>AT₁). The drive characteristic 143 is set so that the arrival time to the arrow 143b is even later than AT₂. In this way, the delay time of the speed rise of the motor 20 is increased in the second group; therefore, the operator who prefers a longer delay time may easily use the drive characteristics of the second group. FIG. 6 shows the characteristics when the trigger lever 6a is fully pulled around time t1; when the trigger lever 6a is operated so that it does not reach 100% of the pull amount, the maximum rotation speed and the arrival time shown in FIG. 6 become lower.

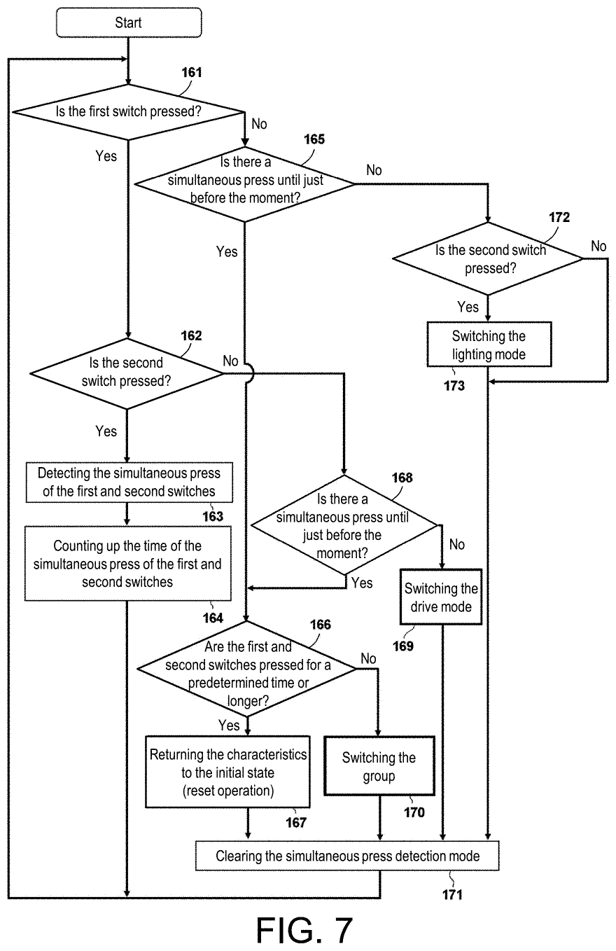

FIG. 7 is a flow chart showing a switching procedure of drive modes in the impact tool 1 of this embodiment. A series of procedures shown in FIG. 7 are implemented in software by the microcomputer 71 (see FIG. 2) executing a program stored in advance in the storage device 72 (see FIG. 2). Further, a series of procedures shown in the flow chart of FIG. 7 is an auxiliary program executed in parallel with the rotation control program (main program) of the motor 20 executed by the microcomputer 71, and it is continuously executed while the microcomputer 71 is activated.

First, the microcomputer 71 determines whether the first switch 61 of the operation panel part 60 (see FIG. 3) is pressed (step 161). Here, when the first switch 61 is pressed, the microcomputer 71 next determines whether the second switch 62 is pressed (step 162). If the second switch 62 is not pressed in step 162, it is determined whether it has been simultaneously pressed with the first switch 61 until just before the moment (step 168). In step 168, if it is not simultaneously pressed, it means that the first switch 61 is operated alone. Therefore, as the operation of the first switch 61 shown in FIG. 4, the drive mode is switched (changed) (step 169), and the process proceeds to step 171. At step 168, if the switches are pressed simultaneously, the process proceeds to step 166.

If the second switch 62 is pressed in step 162, it corresponds to the simultaneous press of the first switch 61 and the second switch 62, so the microcomputer 71 detects the simultaneous press (step 163), and the microcomputer 71 starts counting up the time of the simultaneous press (step 164), and returns to step 161.

If the first switch 61 is not pressed in step 161, the microcomputer 71 determines whether the first switch 61 and the second switch 62 have been simultaneously pressed until just before the moment (step 165). If there is simultaneous press until just before the moment, it means that the group switching operation or the reset operation is performed as shown in FIG. 4, and the process proceeds to step 166. In step 166, it is determined whether the long press time of the first switch 61 and the second switch is a predetermined time, for example, 5 seconds or more, and if it is the predetermined time or longer, as a reset operation, the set group is switched to the first group which is the initial state (default state) (step 167), the simultaneous press detection mode is cleared (step 171), and the process return to step 161. In step 166, if the long press time of the first switch 61 and the second switch is less than the predetermined time, it is not a reset operation, so the drive mode is switched (step 170), and the simultaneous press detection mode is cleared (step 171), and the process return to step 161.

In step 165, if it is determined that the first switch 61 and the second switch 62 are not pressed at the same time, it is not to switch the group, so it is determined whether the second switch 62 is pressed (step 172). Since the second switch 62 is a lighting switch of the lighting device 34, when the second switch 62 is pressed in step 172, the lighting mode is switched (step 173). When the second switch 62 is pressed, for each time it is switched, the lighting mode is switched in the order of continuous lighting, SW interlocking lighting, lighting off, continuous lighting, . . . and the like. If the second switch 62 is not operated in step 172, the simultaneous press detection mode is cleared (step 171), and the process returns to step 161.

By using the first switch 61 and the second switch 62 under the control of the above flow chart, the group switching operation (step 170) and the switching operation of the control characteristics circled 1 to circled 3 (see FIG. 4) (step 169) may be performed.

During the reset operation in step 167 and when the group is switched in step 170, LEDs 66 to 69 (see FIG. 2) may be used to indicate to the operator that the group has been switched. For example, if LEDs capable of displaying multiple colors are used as the LEDs 66 to 69, and the first switch 61 and the second switch 62 are pressed simultaneously, the characteristics after switching are different from the default LEDs 66 to 69 (for example, red), and may be displayed in a different color (for example, blue). Further, it may be configured that only one LED 66 is lit in the case where the characteristics after switching are for the first group, and the two LEDs 66 and 67 are lit in the case where for the second group, and the three LEDs 66 to 68 are lit in the case where for the third group.

These lights may be turned off after being displayed for a predetermined time (for example, 3 seconds). Further, when the first switch 61 and the second switch 62 are simultaneously pressed for a predetermined time or longer, it is determined that a reset operation has been performed, and it may be configured that after the LEDs 66 to 69 blink in blue for a predetermined time, if it has returned to the first group, only one of the LEDs 66 is lit in blue for about 3 seconds. In addition, the performance of the group switching operation and the reset operation may be notified by turning on or blinking the lighting device 34 for a predetermined time. The lighting device 34 corresponds to a notification part in the disclosure. By notifying the performance of the group switching operation and the reset operation by the notification part that is not activated by a drive mode switching operation, it is possible to reliably notify the operator that the groups have been switched and reset.

As described above, according to the work machine of the disclosure, as shown in FIG. 4, multiple drive mode groups are assigned, and the characteristics of the three groups of circled 1 to circled 3 may be switched, so various drive modes may be set. In addition, if the second group and the third group are configured so that the operator may rewrite them from an external connection device (for example, an information terminal such as a smartphone), it is possible to easily realize drive characteristics that suit the preferences of the operator. Further, even if there are sets of groups that may be switched, such as the second group and the third group, and the operator in use does not know which group is being applied, since the reset operation may be performed by simultaneously long pressing the first switch 61 and the second switch 62, a user-friendly work machine may be realized.

Although the disclosure has been described above based on the embodiments, the disclosure is not limited to the above-described embodiments, and various modifications may be made without departing from the scope of the disclosure. For example, although the impact tool 1 has been described as an example of the work machine in the above-described embodiments, the disclosure may be similarly applied to electric tools other than impact tools and electrical equipment for work, as long as it is a work machine having multiple switchable drive modes or a work machine having a variable switch such as a trigger switch and a motor. Furthermore, the power supply for the work machine is not limited to the one using the battery pack, and may be the one using the commercial power supply.

### REFERENCE SIGNS LIST

1: Impact tool; 3: Hammer case; 3a: Through hole; 6: Trigger switch; 6a: Trigger lever; 7: Forward/reverse switching lever; 8: Irradiation window; 9: Control circuit board; 10: Main housing; 11: Body part; 12: Handle part; 13: Battery pack mounting part; 14: Opening; 15: Rear opening; 16a to 16h: Screw boss; 17: Rear cover; 18: Opening surface; 19: Bearing holder; 20: Motor; 21: Stator core; 22: Coil; 23: Rotor core; 24: Permanent magnet; 25: Rotation shaft; 27, 28: Bearing; 30: Circuit board; 31: Hall IC; 33: Cooling fan; 34: Lighting device; 35: Tip tool holding part; 36: Sleeve; 37: Steel ball; 38: Spring; 40: Speed reduction mechanism; 41: Sun gear; 42: Planetary gear; 43: Ring gear; 44: Inner cover; 45: Bearing; 46: Spindle; 47: Cam ball; 48: Hammer spring; 49: Bearing; 50: Rotary impact mechanism; 51: Hammer; 55: Anvil; 56: Blade part; 57: Mounting hole; 60: Operation panel part; 61: First switch; 61a: Switch pressing surface; 62: Second switch; 62a: Switch pressing surface; 63: Protection sheet; 64: Switch holder; 64a to 64d: Display window; 66: First LED; 66a: Soft mode; 67: Second LED; 67a: Power mode; 68: Third LED; 68a: Bolt mode; 69: fourth LED; 69a: Tex mode; 70: Control part; 71: Microcomputer; 72: Storage device; 73: Control signal output circuit; 74: Inverter circuit; 75: Shunt resistor; 76: Constant-voltage power supply circuit; 78: Wireless communication device; 79: Antenna; 80: LED drive circuit; 90: Battery pack; 91: Latch button; 101 to 103: Drive characteristic; 111 to 113: Drive characteristic; 121 to 123: Drive characteristic; 131 to 133: Drive characteristic; 141 to 143: Drive characteristic; 151 to 153: Drive characteristic; A1: Rotation axis

1. A work machine comprising:
a motor;
a drive circuit that supplies electric power to the motor to drive the motor;
a control part that controls the drive circuit;
a start switch for starting to drive the motor; and
a drive mode selection part that selects a drive mode for driving the motor;
wherein the drive mode comprises a plurality of drive modes, and the drive modes have different drive characteristics of the motor,
the control part is capable of collectively switching a part of the drive characteristics of the plurality of drive modes when a selection operation is performed by an operator, and
the selection operation is performed via an external device wirelessly connected to the control part.

2. The work machine according to claim 1,
wherein the control part is capable of collectively switching a part of the drive characteristics of the plurality of drive modes when a first selection operation is performed on the drive mode selection part by an operator, and
the drive mode is selectable when a second selection operation, which is an operation in a different manner from the first selection operation, is performed.

3. (canceled)

4. (canceled)

5. The work machine according to claim 2, further comprising a plurality of indicators for displaying the plurality of drive modes, wherein a display mode of the indicators is changed when the first selection operation is performed.

6. The work machine according to claim 2, further comprising a notification part that notifies that the first selection operation has been performed.

7. The work machine according to claim 2, wherein the first selection operation and the second selection operation are different in at least one of the number of times of operations and an operation time of the drive mode selection switch.

8. The work machine according to claim 2, wherein the drive mode selection part comprises a press button or a touch sensitive switch,
the second selection operation is one press operation of the press button or the touch sensitive switch, and
the first selection operation is a long press operation of the press button or the touch sensitive switch.

9. The work machine according to claim 1, wherein a power supply for the motor is a detachable battery pack,
the work machine further comprises a body part that accommodates the motor, a handle part that extends from the body part, and a battery pack mounting part that is formed at an end of the handle part and away from the body part, and
the drive mode selection part is provided in the battery pack mounting part.

10. The work machine according to claim 1, wherein the control part is provided with a microcomputer and a storage device,
a plurality of parameters for controlling the plurality of drive modes are registered in advance in the storage device.

11. The work machine according to claim 10, further comprising a communication device that enables wireless communication between an external device and the microcomputer, and
the parameters for controlling the plurality of drive modes are rewritable from an outside via the communication device.

12. The work machine according to claim 1, further comprising a reset function for returning to a predetermined drive mode.

13. The work machine according to claim 1, further comprising a reset function for returning settings to factory default settings.

14. A work machine comprising:
a motor;
a drive circuit that supplies electric power to the motor to drive the motor;
a control part that controls the drive circuit;
a start switch for starting to drive the motor; and
a drive mode selection part that selects a drive mode for driving the motor;
wherein the control part is configured to collectively switch the drive mode that is selectable when the drive mode selection part is operated when a selection operation is performed by an operator, and
the selection operation is performed via an external device wirelessly connected to the control part.

15. The work machine according to claim 14, wherein drive modes selectable by operating the drive mode selection part have at least a part of drive characteristics in common before and after the selection operation.

16. The work machine according to claim 14, wherein the number of drive modes selectable by operating the drive mode selection part is same before and after the selection operation.

17. The work machine according to claim 14, wherein a part of drive characteristics comprises at least one of a maximum rotation speed of the motor, a minimum rotation speed of the motor, a slope of an acceleration curve, and an arrival time until reaching the maximum rotation speed.

18. The work machine according to claim 1, wherein the drive modes selectable by operating the drive mode selection part have at least a part of the drive characteristics in common before and after the selection operation.

19. The work machine according to claim 1, wherein the number of the drive modes selectable by operating the drive mode selection part is same before and after the selection operation.

20. The work machine according to claim 1, wherein a part of the drive characteristics comprises at least one of a maximum rotation speed of the motor, a minimum rotation speed of the motor, a slope of an acceleration curve, and an arrival time until reaching the maximum rotation speed.
